(19) United States
(12) Patent Application Publication
(10) Pub. No.: US 2026/0330717 A1
(43) Pub. Date: Oct. 22, 2026

(54) SPECIAL-EFFECT PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Jingye Wang, Beijing (CN); Xiaoqi Li, Beijing (CN)

(21) Appl. No.: 19/123,016

(22) PCT Filed: Oct. 18, 2023
(86) PCT No.: PCT/CN2023/125288

§ 371 Date: Apr. 21, 2025

(30) Foreign Application Priority Data
Oct. 28, 2022 (CN) 202211339065.X

(51) Int. Cl. G06T 11/60; G06T 19/00

(52) U.S. Cl. CPC G06T 11/60; G06T 19/006

(57) ABSTRACT

The disclosed embodiments provide an effect processing method, apparatus, electronic device, and storage medium. An augmented reality image captured by a shooting device is acquired, and a target effect image is generated based on the augmented reality image; when the shooting device displays a first image area of the augmented reality image, a first effect area of the target effect image is displayed in the first image area; when a change in the shooting angle of the shooting device is detected, a second image area of the augmented reality image is displayed, and a second effect area of the target effect image is displayed in the second image area. The target effect image is generated through a virtual display image, and the target effect image can change with the change in the shooting angle of the shooting device, thereby improving the authenticity and vividness of the effect processing effect.

### CROSS-REFERENCE TO RELATED APPLICATION(S)

This application claims priority to Chinese Application No. 202211339065.X filed on Oct. 28, 2022, the disclosure of which is incorporated herein by reference in its entirety.

### FIELD

The embodiments of the present disclosure relate to water surface rendering technology, and more particularly to an effect processing method, apparatus, electronic device and storage medium.

### BACKGROUND

Currently, water surface rendering technology is usually involved in terminal application entertainment scenarios. A virtual camera can be used to shoot and render water surface effect.

In the mobile phone effect scene, a video is generally captured through the rear camera of the mobile phone, and the rendered water surface effect are displayed at a fixed position on the screen. The display effect is relatively dull and less vivid, and compared with the real water surface, the authenticity of the effect is poor.

### SUMMARY

The present disclosure provides an effect processing method, apparatus, electronic device and storage medium to achieve the effect of improving the vividness and authenticity of the effect processing effect.

In a first aspect, an embodiment of the present disclosure provides an effect processing method, wherein the method includes:
obtaining an augmented reality image captured by a shooting device,
generating a target effect image based on the augmented reality image;
displaying a first effect area of the target effect image in a first image area when the shooting device displays the first image area of the augmented reality image; and
displaying a second image area of the augmented reality image and displaying the second effect area of the target effect image in the second image area when it is detected that the shooting angle of the shooting device changes.

In a second aspect, an embodiment of the present disclosure further provides an effect rending apparatus, wherein the apparatus comprises:
an effect generation module configured to obtain an augmented reality image captured by a shooting device, and generate a target effect image based on the augmented reality image;
an effect display module configured to display a first effect area of the target effect image in the first image area when the shooting device displays the first image area of the augmented reality image;
a display change module configured to display a second image area of the augmented reality image and display a second effect area of the target effect image in the second image area when it is detected that the shooting angle of the shooting device changes.

In a third aspect, an embodiment of the present disclosure further provides an electronic device, wherein the electronic device includes:
one or more processors;
a storage apparatus for storing one or more programs,

When the one or more programs are executed by the one or more processors, the one or more processors implement the effect processing method as described in any one of claims 1 to 9.

In a fourth aspect, an embodiment of the present disclosure further provides a storage medium comprising computer executable instructions, wherein the computer executable instructions, when executed by a computer processor, are used to execute the effect processing method as described in any one of claims 1 to 9.

The technical solution of the disclosed embodiment obtains the augmented reality image captured by the shooting device, generates the target effect image based on the augmented reality image, and generates the target effect image with a sense of space through the augmented reality image, which is more in line with the real scene; when the shooting device displays the first image area of the augmented reality image, the first effect area of the target effect image is displayed in the first image area, and the shooting angle is associated with the image display area of the target effect image to ensure the visual presentation effect; when it is detected that the shooting angle of the shooting device changes, the second image area of the augmented reality image is displayed, and the second effect area of the target effect image is displayed in the second image area. The target effect image is generated by a virtual display image, and different effect areas are displayed in the corresponding image area based on the change of the position and angle of the shooting device, and the target effect image can change with the change of the shooting angle of the shooting device, and the change of the shooting angle is used to simulate the change of the user's field of view, and then the change of the actual scene is simulated by displaying different image areas of the target effect image, so that the rendering effect of the target effect image is more real and more vivid, which improves the user experience.

### BRIEF DESCRIPTION OF THE DRAWINGS

The above and other features, advantages and aspects of the embodiments of the present disclosure will become more apparent with reference to the following detailed description in conjunction with the accompanying drawings. Throughout the accompanying drawings, the same or similar reference numerals represent the same or similar elements. It should be understood that the drawings are schematic and the originals and elements are not necessarily drawn to scale.

FIG. 1 is a schematic diagram of a flow chart of an effect processing method provided by an embodiment of the present disclosure;

FIG. 2 is a flow chart of another effect processing method provided by an embodiment of the present disclosure;

FIG. 3 is a flow chart of another effect processing method provided by an embodiment of the present disclosure;

FIG. 4 is a caustic light map provided by an embodiment of the present disclosure;

FIG. 5 is a normal texture map provided by an embodiment of the present disclosure;

FIG. 6 is a flow chart of another effect processing method provided by an embodiment of the present disclosure;

FIG. 7 is a flow chart of an optional example of an effect processing method provided by an embodiment of the present disclosure;

FIG. 8 is a schematic diagram of the structure of an effect processing apparatus provided by an embodiment of the present disclosure;

FIG. 9 is a schematic diagram of the structure of an effect processing electronic device provided by an embodiment of the present disclosure.

### DETAILED DESCRIPTION OF EMBODIMENTS

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments described herein, which are instead provided for a more thorough and complete understanding of the present disclosure. It should be understood that the drawings and embodiments of the present disclosure are only for exemplary purposes and are not intended to limit the scope of protection of the present disclosure.

It should be understood that the various steps described in the method embodiments of the present disclosure may be performed in different orders and/or in parallel. In addition, the method embodiments may include additional steps and/or omit the steps shown. The scope of the present disclosure is not limited in this respect.

The term “including” and its variations used herein are open inclusions, i.e., “including but not limited to”. The term “based on” means “based at least in part on”. The term “one embodiment” means “at least one embodiment”; the term “another embodiment” means “at least one additional embodiment”; the term “some embodiments” means “at least some embodiments”. The relevant definitions of other terms will be given in the following description.

It should be noted that the concepts such as “first” and “second” mentioned in the present disclosure are only used to distinguish different devices, modules or units, and are not used to limit the order or interdependence of the functions performed by these devices, modules or units.

It should be noted that the modifications of “one” and “plurality” mentioned in the present disclosure are illustrative rather than restrictive, and those skilled in the art should understand that unless otherwise clearly indicated in the context, it should be understood as “one or more”.

The names of the messages or information exchanged between multiple apparatuses in the embodiments of the present disclosure are only used for illustrative purposes and are not used to limit the scope of these messages or information.

It is understandable that before using the technical solutions disclosed in the embodiments of the present disclosure, the types, scope of use, usage scenarios, etc. of the personal information involved in the present disclosure should be informed to the user and the user's authorization should be obtained in an appropriate manner in accordance with relevant laws and regulations.

For example, in response to receiving an active request from a user, a prompt message is sent to the user to clearly prompt the user that the operation requested to be performed will require acquiring and using the user's personal information. Thus, the user can autonomously choose whether to provide personal information to software or hardware such as an electronic device, application, server, or storage medium that performs the operation of the technical solution of the present disclosure according to the prompt message.

As an optional but non-limiting implementation, in response to receiving an active request from the user, the prompt information may be sent to the user in the form of a pop-up window, in which the prompt information may be presented in text form. In addition, the pop-up window may also carry a selection control for the user to choose “agree” or “disagree” to provide personal information to the electronic device.

It can be understood that the above notification and the process of obtaining user authorization are merely illustrative and do not constitute a limitation on the implementation of the present disclosure. Other methods that meet the relevant laws and regulations may also be applied to the implementation of the present disclosure.

It can be understood that the data involved in this technical solution (including but not limited to the data itself, the acquisition or use of the data) shall comply with the requirements of relevant laws, regulations and relevant provisions.

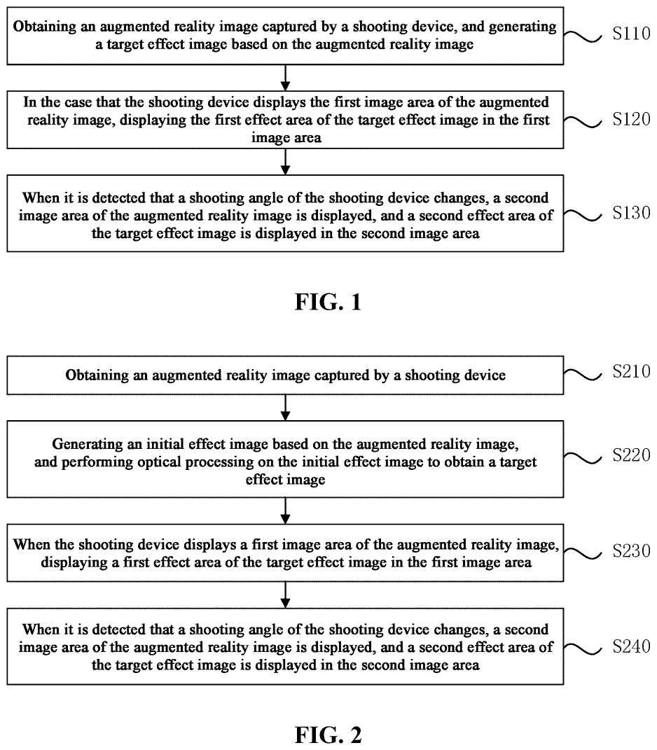

FIG. 1 is a flow chart of an effect processing method provided by an embodiment of the present disclosure. The embodiment of the present disclosure is applicable to the case of rendering an effect image with a stereoscopic sense. The method can be executed by an effect processing apparatus, which can be implemented in the form of software and/or hardware. Optionally, it can be implemented by an electronic device, which can be a mobile terminal, a PC or a server, etc. The embodiment of the present disclosure is particularly applicable to a mobile terminal provided with an augmented reality (AR) shooting device.

As shown in FIG. 1, the method of this embodiment may specifically include:

S110: obtaining an augmented reality image captured by a shooting device, and generating a target effect image based on the augmented reality image.

Among them, the shooting device can be understood as a device for shooting the augmented reality image. Optionally, the shooting device can be a device with a shooting function and an AR component installed, and has a shooting function. The shooting device can also be used to display the effect image obtained after the augmented reality image is processed with effect. In the embodiment of the present disclosure, the terminal can be preset according to the scene requirements, and no specific limitation is made here. Exemplarily, the shooting device can be an AR camera or an augmented reality AR device (such as AR glasses) configured in the terminal. It can be understood that the specific image content of the augmented reality image can be determined according to the actual shooting scene, and no specific limitation is made here. Optionally, the augmented reality image can be a single frame image in the augmented reality video, or it can be an augmented reality image.

Among them, the target effect image can be understood as an effect image obtained by performing effect processing on the augmented reality image. In the embodiment of the present disclosure, the effect of the target effect image can be preset according to the scene requirements, and no specific limitation is made here. Exemplarily, the outline of the target effect image may be irregular. Optionally, the target effect image may have multiple forms of expression, for example, it may be an effect image obtained by performing water surface effect rendering, snow mountain effect rendering, flame effect rendering, or stream sand effect rendering on the augmented reality image. Exemplarily, the target effect image may be a water surface effect image. Furthermore, the edge of the water surface effect image may be nonlinear to simulate the scene of water surface fluctuations.

In an embodiment of the present disclosure, the augmented reality image obtained by the shooting device may include the scene depth information of the augmented reality image, that is, the distance between each pixel in the augmented reality image and the shooting device. Optionally, generating a target effect image based on the augmented reality image includes: obtaining a depth estimation map of the augmented reality image, and generating a target effect image based on the depth estimation map. The depth data of each pixel in the depth estimation map can be used to indicate the distance from the scene information corresponding to the pixel to the shooting device.

Exemplarily, generating a target effect image based on the depth estimation map includes: determining an effect rendering area corresponding to the augmented reality image; for each pixel to be rendered in the effect rendering area, determining the pixel value of the pixel to be rendered based on the depth information corresponding to the pixel to be rendered in the depth estimation map; and rendering to obtain the target effect image based on the pixel value of each pixel to be rendered in the effect rendering area.

Optionally, determining the effect rendering area corresponding to the augmented reality image includes: determining the effect rendering area corresponding to the augmented reality image based on a preset area generation algorithm; or, in response to an effect application trigger operation for the augmented reality image, obtaining the effect rendering area based on the triggered effect. The effect application trigger operation can be understood as a trigger operation acting on the augmented reality image for starting a default effect, or an effect selection operation for at least one effect, etc.

S120: in the case that the shooting device displays the first image area of the augmented reality image, displaying the first effect area of the target effect image in the first image area.

It is understandable that when the shooting angle of the shooting device changes, the image area of the augmented reality image displayed by the shooting device can change accordingly. In other words, in response to the change in the image area of the displayed augmented reality image, the corresponding effect area can be displayed in different image areas of the target effect image. In the embodiment of the present disclosure, the presentation effect of different image areas of the target effect image can be the same or different.

The first image area can be understood as the image area corresponding to the current shooting angle of the shooting device in the augmented reality image. The first effect area can be understood as the effect area displayed in the target effect image corresponding to the first image area.

Specifically, in the case that the shooting device displays the first image area of the augmented reality image, the effect area corresponding to the first image area in the target effect image is obtained as the first effect area, and the first effect area is displayed in the first image area.

S130: when it is detected that a shooting angle of the shooting device changes, a second image area of the augmented reality image is displayed, and a second effect area of the target effect image is displayed in the second image area.

Among them, the shooting angle can be understood as the angle at which the shooting device shoots the augmented reality image. Optionally, the shooting angle can be determined based on information such as the shooting position and/or shooting direction when the shooting device acquires the augmented reality image.

Among them, the second image area can be understood as the image area of the augmented reality image captured by the terminal after the shooting angle of the shooting device changes. The second effect area can be understood as the effect area displayed in the target effect image corresponding to the second image area. Optionally, the first image area and the second image area can be different, and the first effect area and the second effect area can be different.

Specifically, when it is detected that the shooting angle of the shooting device has changed, the second image area of the augmented reality image captured by the shooting device is obtained, the second image area is displayed, and the second effect area of the target effect image is displayed in the second image area.

In order to enrich the display effect of effect, a preset effect object can be added to the target effect image. Optionally, the effect processing method also includes: rendering a preset effect object into the target effect image. Among them, the effect object can be understood as an object rendered in the target effect image. In the embodiment of the present disclosure, the specific form and display method of the effect object and other information can be preset according to needs, and no specific limitation is made here. Optionally, the effect object can be a preset effect prop. Different target effect images can use the same or different effect objects. Exemplarily, taking the target effect image as a water surface as an example, the effect object can be a floating object on the water surface and/or aquatic creatures, such as a ship, fish, and water plants.

Optionally, rendering the preset effect object into the target effect image includes: determining target display information of the preset effect object in the target effect image, and rendering the effect object into the target effect image with the target display information. By rendering the preset effect object into the target effect image with the target display information, the rendering effect of the target effect image can be enriched.

Among them, the target display information can be understood as information used to indicate how the effect object is displayed in the target effect image. In the embodiment of the present disclosure, the target display information can be preset according to the scene requirements and is not specifically limited here. Optionally, the target display information may include but is not limited to at least one of display position, motion state, display color, and display depth.

Among them, the motion state can be understood as indicating whether the effect object moves, and in what manner the effect object moves when the effect object moves. In the disclosed embodiment, for example, the motion state of the effect object in the target effect image can be a state simulating the motion of a pendulum, etc.

Optionally, the motion state includes dynamic or static. Exemplarily, the effect object can be displayed in the target effect image in a static or dynamic manner.

Optionally, when the effect object moves, the motion state may also include but is not limited to at least one of the motion information such as the motion angle, motion amplitude, motion time, motion trajectory and motion speed of the effect object in the target effect image.

Among them, the display color information can be understood as the color information of the effect object displayed in the target effect image. Optionally, the display color information is determined based on the display position of the effect object in the target effect image. Specifically, it can be determined based on the color value and/or depth data of the pixel at the display position of the effect object in the target effect image.

Among them, the display depth information can be understood as the depth information of the effect object displayed in the target effect image. It can be understood that, for the effect object, the display depth information of different object areas may be different. In the embodiment of the present disclosure, optionally, the effect object is rendered based on the display depth information of each object area of the pre-set effect object in the target effect image. In the embodiment of the present disclosure, the impact of the effect can be presented based on the display depth of the effect object and the target effect image. By adopting this technical solution, the impact of the effect can be achieved in which a part of the area of the effect object obstructs the target effect image, or the target effect image obstructs a part of the area of the effect object.

The technical solution of the disclosed embodiment obtains the augmented reality image captured by the shooting device, generates the target effect image based on the augmented reality image, and can generate the target effect image with a sense of space through the augmented reality image, which is more in line with the real scene; when the shooting device displays the first image area of the augmented reality image, the first effect area of the target effect image is displayed in the first image area, and the shooting angle is associated with the image display area of the target effect image to ensure the visual presentation effect; when it is detected that the shooting angle of the shooting device changes, the second image area of the augmented reality image is displayed, and the second effect area of the target effect image is displayed in the second image area. The target effect image is generated through a virtual display image, and the target effect image can change with the change of the shooting angle of the shooting device. The change of the shooting angle is used to simulate the change of the user's field of view, and then the change of the actual scene is simulated by displaying different image areas of the target effect image, so that the rendering effect of the target effect image is more realistic and vivid, and the user experience is improved.

FIG. 2 is a flow chart of another effect processing method provided by an embodiment of the present disclosure. This embodiment is a refinement of the method of generating a target effect image based on the augmented reality image described in the above embodiment. Optionally, the specific implementation method can refer to the description of this embodiment. Among them, the technical features that are the same or similar to the above embodiments are not repeated here.

As shown in FIG. 2, the method of this embodiment may specifically include:

S210: obtaining an augmented reality image captured by a shooting device.

S220: generating an initial effect image based on the augmented reality image, and performing optical processing on the initial effect image to obtain a target effect image.

Among them, the optical processing includes at least one of a scattering processing, a reflection processing, a refraction processing, a caustic processing and a highlight processing.

Among them, the initial effect image can be understood as an effect image initially generated based on the augmented reality image. The optical processing can be understood as a process of processing each pixel in the initial effect image based on optical information. Optionally, the optical processing can be at least one of a scattering processing, a reflection processing, a refraction processing, a caustic processing and a highlight processing.

Among them, the scattering processing may be understood as a method of processing at least part of the pixels in the initial effect image based on the scattering of light so that the initial effect image presents an effect of scattered light.

In the disclosed embodiment, by performing scattering processing on the initial effect image, the pixels at different distances from the terminal in the initial effect image can present different brightness and darkness, making the optical effect of the initial effect image more realistic. Exemplarily, scattering processing is performed on the initial water surface effect image, and the target effect image obtained can be a water surface far from the shooting device, with a darker color, and a water surface close to the shooting device, with a brighter color, thereby improving the authenticity of the water surface effect rendering.

Among them, the reflection processing can be understood as a processing method of processing at least part of the pixels in the initial effect image based on the reflection of light, so that the initial effect image presents an effect of emitting light. Optionally, the reflection processing can be a process of processing the optical information of the pixels on the water surface in the initial water surface effect image. The refraction processing can be understood as a processing method of processing at least part of the pixels in the initial effect image based on the refraction of light, so that the initial effect image presents an effect of refracting light. Optionally, the refraction processing can be a process of processing the optical information of the pixels below the water surface in the initial water surface effect image. In the embodiment of the present disclosure, reflection processing and refraction processing are performed on the initial effect image, so that the pixels on the water surface and below the water surface in the water surface image present different optical effect, thereby improving the authenticity of the water surface effect rendering.

In the disclosed embodiment, the initial effect image can be subjected to caustic processing by the method of sampling a preset caustic light map. It can be understood that the caustic light map and the sampling method of the caustic light map can be different according to different shooting angles of the shooting device. In the processing of the water surface effect image, the caustic processing can make the water surface effect image simulate the impact of shimmering effect of the real water surface under the light.

Among them, highlight processing can be understood as a process of making a partial area of the initial effect image present an optical effect of completely reflecting the light source. Optionally, the initial effect image is processed based on a preset highlight algorithm. Exemplarily, the preset highlight algorithm may include but is not limited to the Blinn-Phong lighting algorithm.

Exemplarily, the optical processing may include reflection processing and refraction processing. Optionally, performing an optical processing on the initial effect image, including: determining the direction of the refracted light according to the preset incident light and the target effect image, sampling the augmented reality image according to the refracted light direction to obtain the refracted color value; determining the direction of the reflected light according to the preset incident light and the target effect image, sampling the preset environment map according to the reflected light direction to obtain the reflected color value; determining the reflectivity corresponding to the reflected color value and the refractive index corresponding to the refraction color value, and processing the initial effect image according to the refraction color value, the refractive index, the reflected color value and the reflectivity.

Among them, the preset incident light is determined based on the illumination direction of a preset light source. The refracted light direction can be understood as the light direction determined by the refractive index of the preset incident light and the target effect image. The refracted color value can be understood as the color value obtained by sampling the augmented reality image according to the refracted light direction. The refractive index can be understood as the percentage of the radiant energy of the refracted light to the radiant energy of the preset incident light. It can be understood that the refractive index can be preset according to the scene requirements and is not specifically limited here. Specifically, the larger the refractive index, the brighter the brightness and darkness of the image pixel of the image corresponding to the refractive index can be.

Among them, the direction of reflected light can be understood as the direction of light determined by the preset incident light and the reflectivity of the water surface in the target effect image. The preset environment map can be understood as a map that represents the color value corresponding to the direction of the refracted light. The reflected color value can be understood as the color value obtained by sampling the preset environment map according to the direction of the reflected light. The reflectivity can be understood as the percentage of the radiant energy of the reflected light to the radiant energy of the preset incident light. It can be understood that the reflectivity can be preset according to the scene requirement and is not specifically limited here. Specifically, the greater the reflectivity, the brighter the brightness and darkness of the image pixel corresponding to the reflectivity can be. Taking the rendering of the water surface effect image as an example, under normal circumstances, the brightness of the image pixel below the water surface will be darker, and the brightness of the image pixel on the water surface will be brighter.

S230: when the shooting device displays a first image area of the augmented reality image, displaying a first effect area of the target effect image in the first image area.

S240: when it is detected that the shooting angle of a shooting device changes, a second image area of the augmented reality image is displayed, and a second effect area of the target effect image is displayed in the second image area.

The technical solution of the disclosed embodiment generates an initial effect image based on the augmented reality image, and optically processes the initial effect image to obtain a target effect image, so that the rendered water surface effect simulates the optical effect of scattering, reflection, refraction, caustics, and highlights of the real water surface, thereby improving the vividness and authenticity of the target effect image.

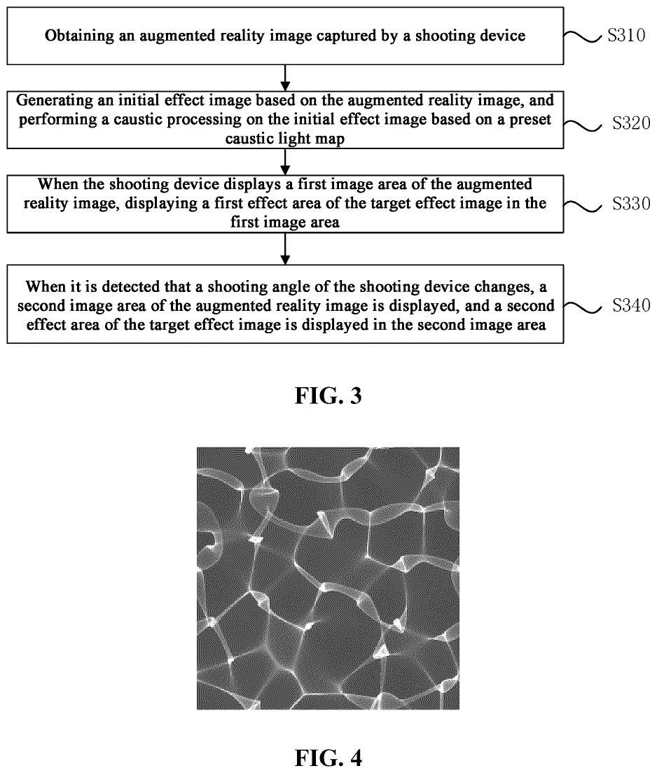

FIG. 3 is a flow chart of another effect processing method provided by an embodiment of the present disclosure. This embodiment refines the optical processing of the initial effect image described in the above embodiment.

As shown in FIG. 3, the method includes:

S310: obtaining an augmented reality image captured by a shooting device.

S320: generating an initial effect image based on the augmented reality image, and performing a caustic processing on the initial effect image based on a preset caustic light map.

The caustic map can be understood as a map that represents the caustic characteristics. The caustic map can be configured according to actual needs and is not specifically limited here, as long as it can represent the caustic characteristics. For example, the caustic map can be shown in FIG. 4.

In the embodiment of the present disclosure, the caustic color value of each pixel in the initial effect image can be determined based on the caustic light map to perform caustic processing on the initial effect image.

Optionally, performing the caustic processing on the initial effect image based on a preset caustic light map includes: determining, for each image pixel to be subjected to a caustic processing in the initial effect image, caustic sampling coordinate corresponding to the image pixel; performing a sampling processing on the preset caustic light map based on the caustic sampling coordinate, and determining the caustic color value corresponding to the image pixel based on the sampling result; and performing caustic processing on the image pixel based on the caustic color value corresponding to the image pixel.

Among them, the image pixel can be understood as each pixel to be subjected to caustic processing in the initial effect image. The caustic sampling coordinate can be understood as the coordinate on which the caustic light map can be sampled to obtain the caustic color value corresponding to the image pixel. The sampling processing can be understood as a processing process of sampling the preset caustic light map based on the caustic sampling coordinate to obtain the caustic color value corresponding to the image pixel. The caustic color value can be understood as the color value of the pixel corresponding to the image pixel in the preset caustic light map obtained by the sampling processing.

Optionally, determining the caustic sampling coordinate corresponding to the image pixel includes: determining the normal sampling coordinate corresponding to a preset normal texture map based on the world coordinate of the image pixel and the lighting direction coordinate of a preset light source; and determining the caustic sampling coordinate corresponding to the image pixel based on the normal sampling coordinate.

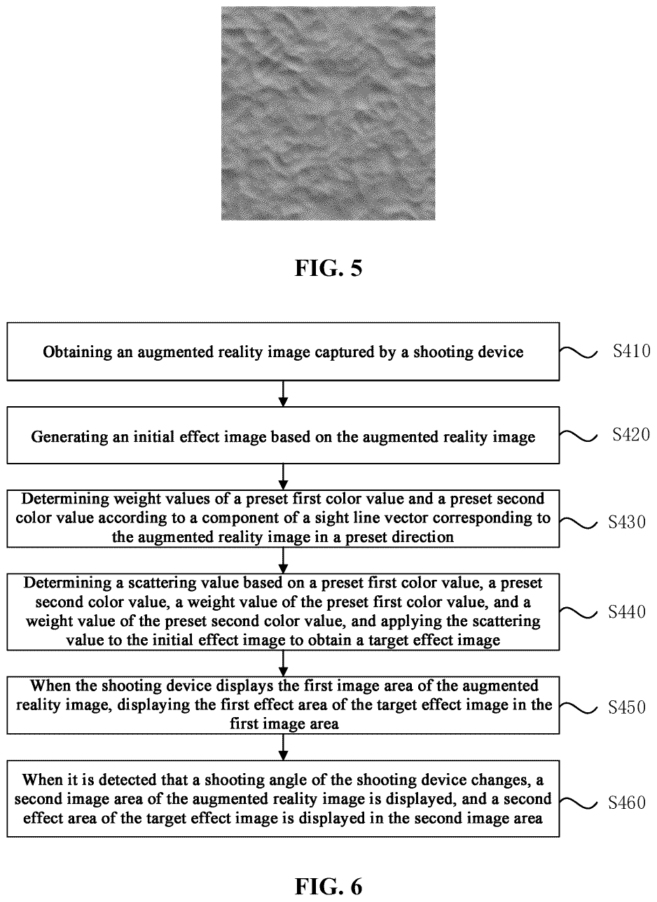

Among them, the world coordinate can be understood as coordinate composed of three mutually perpendicular and intersecting coordinate axes. The preset light source can be understood as an object that provides incident light. In the embodiment of the present disclosure, the preset light source can be preset according to needs and is not specifically limited here. The illumination direction coordinate can be understood as the illumination direction coordinate of the incident light. The normal texture map can be understood as a map of the normal texture that characterizes the ripple characteristics of the water surface (for a specific example, refer to FIG. 5). In the embodiment of the present disclosure, the caustic sampling coordinates corresponding to each pixel of the image can be determined based on the normal texture map. The normal sampling coordinate can be understood as the coordinate sampled for the normal texture map.

Specifically, determining the world coordinate and the illumination direction coordinate of the preset light source, obtaining the two-dimensional vector of the world coordinate and the illumination direction of the preset light source, and obtaining the normal sampling coordinate that can be sampled in the preset texture map by calculation. Specifically, calculating the first ratio of the vertical component (i.e., y component) of the world coordinate of the image pixel and the vertical component (i.e., y component) of the illumination direction coordinate; use the product of the first ratio and the vertical component (i.e., x component) of the illumination direction coordinate and the sum of the transverse component (i.e., x component) of the world coordinate of the image pixel as the transverse coordinate of the normal sampling coordinate on the normal texture map, and use the product of the first ratio and the vertical component (i.e., z component) of the illumination direction coordinates and the sum of the vertical component (i.e., z component) of the world coordinate of the image pixel as the vertical coordinate of the normal sampling coordinate on the normal texture map.

Furthermore, the normal sampling points in the normal texture map are determined based on the normal sampling coordinates, and the caustic sampling coordinates corresponding to the image pixels are determined based on the coordinates of the normal sampling points. Specifically, the horizontal and vertical coordinate components (i.e., the x component and the y component) of the normal sampling points can be used as the caustic sampling coordinates corresponding to the image pixels. Then, the preset caustic light map is sampled based on the caustic sampling coordinate to obtain the caustic map value corresponding to each image pixel.

Optionally, determining the caustic color value corresponding to the image pixel based on the sampling result includes: determining the caustic color value corresponding to the image pixel based on the caustic map value corresponding to the image pixel. Specifically, calculating the difference between the vertical axis component (i.e., y component) of the world coordinate of the image pixel and a first preset value, then calculating a second ratio of the difference to a second preset value, taking the difference between 1 and the second ratio as a first factor, taking the caustic map value corresponding to the image pixel as a second factor, and multiplying the first factor by the second factor to obtain the caustic color value corresponding to the image pixel.

On this basis, the initial effect image may be processed by combining one or more of scattering processing, reflection processing, refraction processing and highlight processing to obtain a target effect image.

S330: when the shooting device displays a first image area of the augmented reality image, displaying a first effect area of the target effect image in the first image area.

S340: when it is detected that the shooting angle of the shooting device changes, a second image area of the augmented reality image is displayed, and a second effect area of the target effect image is displayed in the second image area.

Solution of the disclosed embodiment performs caustic processing on the initial effect image based on a preset caustic light map, so that the target effect image can present a shimmering dynamic effect, thereby improving the vividness and authenticity of the effect rendering.

FIG. 6 is a flow chart of another effect processing method provided by an embodiment of the present disclosure. This embodiment refines the optical processing of the initial effect image described in the above embodiment.

As shown in FIG. 6, the method includes:

S410: obtaining an augmented reality image captured by a shooting device.

S420: generating an initial effect image based on the augmented reality image.

S430: determining weight values of a preset first color value and a preset second color value according to a component of a sight line vector corresponding to the augmented reality image in a preset direction.

In this embodiment, the sight line vector can be understood as a vector from the shooting device to the pixel of the image to be subjected to caustic processing. The preset direction can be the vertical axis direction of the sight line vector.

In an embodiment of the present disclosure, scattering processing is performed on the initial effect image, so that the processed initial effect image can present a color gradient effect. Exemplarily, two different color values can be pre-set to represent the color value of the image pixel farthest from the terminal and the color value of the image pixel closest to the terminal, respectively. Specifically, a preset first color value is used to represent the color value of the image pixel farthest from the terminal. The preset second color value represents the color value of the image pixel closest to the terminal. Optionally, scattering processing is performed on the initial effect image, including: processing the initial effect image according to a preset first color value, a preset second color value, and the depth data of each pixel corresponding to the initial effect image. Among them, the depth data of each pixel can be determined based on the value of the component of the sight vector of the pixel on the vertical axis (i.e., the y-axis).

Specifically, for each pixel point, the first weight of the preset first color and the second weight of the preset second color can be determined respectively according to the value of the y component of the normalized line-of-sight vector, and then the scattered light value is determined based on the preset first color, the first weight, the preset second color and the second weight, and then the color value of the pixel is determined based on the scattered light value.

Furthermore, the value of the y component of the normalized line-of-sight vector may be used as the first weight of the preset first color, and the difference between 1 and the first weight may be used as the second weight of the preset second color.

It can be understood that in the embodiment of the present disclosure, the preset first color value and the preset second color value can be preset according to scene requirements, and are not specifically limited here. Optionally, when the initial effect image is a water surface image, the first color value can be a darker water surface color, and the second color value can be a lighter water surface color.

S440: determining a scattering value based on a preset first color value, a preset second color value, a weight value of the preset first color value, and a weight value of the preset second color value, and applying the scattering value to the initial effect image to obtain a target effect image.

Specifically, a first product obtained by multiplying a preset first color by a first weight and a second product obtained by multiplying a preset second color by a second weight are summed to obtain a scattered light value, and the scattered light value is then applied to the initial effect image.

On this basis, the initial effect image may be processed in combination with one or more of reflection processing, refraction processing, caustic processing and highlight processing to obtain a target effect image.

S450: when the shooting device displays the first image area of the augmented reality image, displaying the first effect area of the target effect image in the first image area.

S460: when it is detected that the shooting angle of the shooting device changes, a second image area of the augmented reality image is displayed, and a second effect area of the target effect image is displayed in the second image area.

The technical solution of the disclosed embodiment determines the weight values of the preset first color value and the preset second color value respectively according to the component of the sight line vector corresponding to the augmented reality image in the preset direction; determines the scattering value based on the preset first color value, the preset second color value, the weight value of the preset first color value and the weight value of the preset second color value, and applies the scattering value to the initial effect image. This can make the target effect image have a visual effect of far and near differences, and improve the authenticity of effect rendering.

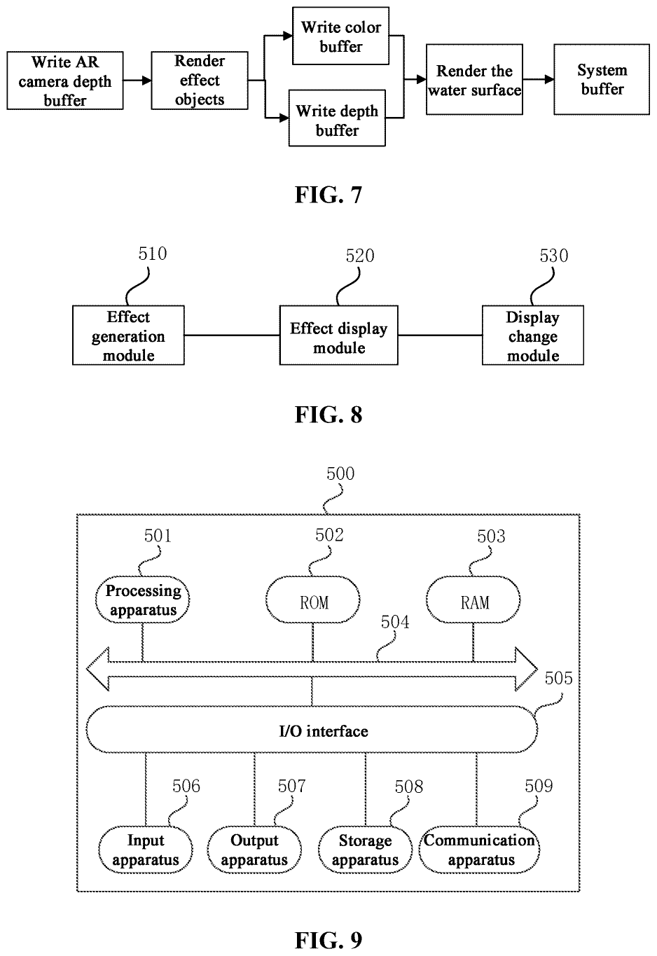

FIG. 7 is a flowchart of an optional example of an effect processing method provided by an embodiment of the present disclosure. Taking the processing of a water surface effect image as an example, as shown in FIG. 7, the overall flow of the effect processing method can be:
1. Obtaining the augmented reality image. The augmented reality image containing depth information is captured by a terminal equipped with an AR camera, and obtaining the depth estimation map in the scene based on the AR camera assembly, and writing it into the depth buffer of the AR camera.
2. Rendering effect objects. Rendering an effect object floating on the water surface in the water surface effect image, such as dragon boats.
3. Calculating the display color of the effect object and write it into the color buffer, and calculate the display depth of the effect object and write it into the depth buffer.
4. Rendering the water surface. Water surface rendering can be the result of comprehensive consideration of scattering, reflection, refraction, caustics and highlights. Among them,
1) Scattering: the value of the y component of the normalized line-of-sight vector is used as the first weight of the preset first color, the difference between 1 and the first weight is used as the second weight of the preset second color, and the first product obtained by multiplying the preset first color by the first weight and the second product obtained by multiplying the preset second color by the second weight are summed to obtain the scattered light value.
2) Refraction and reflection: determining the direction of the refracted light, and sampling the augmented reality image according to the refracted light direction to obtain the refracted color value; determining the direction of the reflected light, and sampling the preset environment map according to the reflected light direction to obtain the reflected color value. The refracted color value and the reflected color value are mixed according to the mixing coefficient calculated by the Schlick approximation method of the Fresnel law.
3) Caustics: the product of the ratio of the vertical axis component (i.e., y component) of the world coordinates of the image pixel to the vertical axis component (i.e., y component) of the illumination direction coordinate and the vertical axis component (i.e., x component) of the illumination direction coordinate is taken as the first parameter, the horizontal axis component (i.e., x component) of the world coordinates of the image pixel is taken as the second parameter, the sum of the first parameter and the second parameter is taken as the horizontal coordinate of the normal sampling coordinate on the normal texture map, the product of the ratio of the vertical axis component (i.e., y component) of the world coordinates of the image pixel to the vertical axis component (i.e., y component) of the illumination direction coordinate and the vertical axis component (i.e., z component) of the illumination direction coordinate is taken as the third parameter, the vertical axis component (i.e., z component) of the world coordinates of the image pixel is taken as the fourth parameter, and the sum of the third parameter and the fourth parameter is taken as the vertical coordinate of the normal sampling coordinate on the normal texture map. Further, the normal texture map is sampled based on the horizontal coordinate and the vertical coordinate of the normal sampling coordinate to obtain a normal sampling point. The horizontal and vertical coordinate components (i.e., x component and y component) of the normal sampling point are used as the horizontal and vertical coordinate components of the caustic sampling coordinates corresponding to the image pixel. Then, based on the caustic sampling coordinates, a preset caustic light map is sampled to obtain a caustic map value corresponding to each image pixel.
4) Highlight: using the Blinn-Phong method to determine the highlight color value.
5) Writing the water surface rendering results into the system buffer to display the image area of the water surface effect image according to the shooting angle of the shooting device.

The technical solution of this embodiment renders the water surface based on the augmented reality image obtained by the shooting device equipped with AR assembly, and performs various optical processing on the surface, rendering the conventional rectangular horizontal plane into a three-dimensional (3D) water surface effect, thereby improving the authenticity of the effect processing effect. Moreover, different water surface effect areas can be displayed in the corresponding image area according to the change of the shooting angle, thereby improving the vividness of the effect processing effect and enhancing the user experience.

FIG. 8 is a schematic diagram of the structure of an effect processing apparatus provided by an embodiment of the present disclosure. As shown in FIG. 8, the device includes: an effect generating module 510, an effect display module 520, and a display changing module 530.

Among them, the effect generation module 510 is configured to obtain the augmented reality image captured by the shooting device, and generate a target effect image based on the augmented reality image; the effect display module 520 is configured to display the first effect area of the target effect image in the first image area when the shooting device displays the first image area of the augmented reality image; the display change module 530 is configured to display the second image area of the augmented reality image when it is detected that the shooting angle of the shooting device changes, and display the second effect area of the target effect image in the second image area.

The technical scheme of the disclosed embodiment obtains the augmented reality image captured by the shooting device, generates the target effect image based on the augmented reality image, and can generate the target effect image with a sense of space through the augmented reality image, which is more in line with the real scene; when the shooting device displays the first image area of the augmented reality image, the first effect area of the target effect image is displayed in the first image area, and the shooting angle is associated with the image display area of the target effect image to ensure the visual presentation effect; when it is detected that the shooting angle of the shooting device changes, the second image area of the augmented reality image is displayed, and the second effect area of the target effect image is displayed in the second image area. The target effect image is generated through a virtual display image, and the target effect image can change with the change of the shooting angle of the shooting device. The change of the shooting angle is used to simulate the change of the user's field of view, and then the change of the actual scene is simulated by displaying different image areas of the target effect image, so that the rendering effect of the target effect image is more realistic and vivid, and the user experience is improved.

Optionally, the effect generation module 510 includes: an optical processing submodule.

Among them, the optical processing submodule is configured to generate an initial effect image based on the augmented reality image, and perform an optical processing on the initial effect image to obtain a target effect image, wherein the optical processing includes at least one of a scattering processing, a reflection processing, a refraction processing, a caustic processing and a highlight processing.

Optionally, the optical processing submodule includes: a caustic processing unit.

Among them, the caustic processing unit is configured to perform caustic processing on the initial effect image based on a preset caustic light map.

Optionally, the caustic processing unit includes: a caustic sampling coordinate determination subunit, a caustic color value acquisition subunit and a caustic processing subunit.

Among them, caustic sampling coordinate determination subunit is configured to determine the caustic sampling coordinate corresponding to each image pixel to be subjected to caustic processing in the initial effect image;
The caustic color value acquisition subunit is configured to sample a preset caustic light map based on the caustic sampling coordinates, and determine a caustic color value corresponding to the image pixel based on the sampling result;
The caustic processing subunit is configured to perform caustic processing on the image pixel based on the caustic color value corresponding to the image pixel.

Optionally, the caustic sampling coordinate determination subunit is configured to:
determine the sampling coordinate corresponding to a preset normal texture map according to the world coordinate of the image pixel and the illumination direction coordinates of a preset light source;
determine the caustic sampling coordinate corresponding to the image pixel according to the normal sampling coordinates.

Optionally, the optical processing submodule includes a caustic processing unit, which is configured to:
determine the weight values of a preset first color value and a preset second color value respectively according to a component of a sight line vector corresponding to the augmented reality image in a preset direction;
determine the scattering value based on a preset first color value, a preset second color value, a weight value of the preset first color value, and a weight value of the preset second color value, and the scattering value is applied to the initial effect image.

Optionally, the optical processing submodule includes a reflection processing unit and a refraction processing unit, which are configured to:
determine the direction of the refracted light according to the preset incident light and the target effect image, and sample the augmented reality image according to the direction of the refracted light to obtain a refracted color value;
determine the direction of reflected light according to the preset incident light and the target effect image, and sample the preset environment map according to the direction of reflected light to obtain a reflected color value;
determine the reflectivity corresponding to the reflection color value and the refractive index corresponding to the refraction color value, and process the initial effect image according to the refraction color value, the refractive index, the reflection color value and the reflectivity.

Optionally, the effect processing method further includes an effect object rendering module, which is configured to:
render the preset effect object into the target effect image.

Optionally, the effect object rendering module is configured to:
determine target display information of a preset effect object in the target effect image, and render the effect object into the target effect image with the target display information, wherein the target display information includes at least one of display position, motion state, display color and display depth.

The effect processing apparatus provided in the embodiments of the present disclosure can execute the effect processing method provided in any embodiment of the present disclosure, and has the corresponding functional modules and beneficial effect of the execution method.

It is worth noting that the various units and modules included in the above-mentioned device are only divided according to functional logic, but are not limited to the above-mentioned division, as long as the corresponding functions can be achieved; in addition, the specific names of the functional units are only for the convenience of distinguishing each other, and are not used to limit the protection scope of the embodiments of the present disclosure.

FIG. 9 is a schematic diagram of the structure of an effect processing electronic device provided by an embodiment of the present disclosure. Referring to FIG. 9 below, it shows a schematic diagram of the structure of an electronic device (such as a terminal device or server in FIG. 9) 500 suitable for implementing an embodiment of the present disclosure. The terminal device in the embodiment of the present disclosure may include, but is not limited to, mobile terminals such as mobile phones, laptop computers, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 9 is only an example and should not bring any limitations to the functions and scope of use of the embodiments of the present disclosure.

As shown in FIG. 9, the electronic device 500 may include a processing apparatus (e.g., a central processor, a graphics processor, etc.) 501, which can perform various appropriate actions and processes according to a program stored in a read-only memory (ROM) 502 or a program loaded from a storage apparatus 508 into a random access memory (RAM) 503. Various programs and data required for the operation of the electronic device 500 are also stored in the RAM 503. The processing apparatus 501, the ROM 502, and the RAM 503 are connected to each other via a bus 504. An input/output (I/O) interface 505 is also connected to the bus 504.

Typically, the following devices may be connected to the I/O interface 505: an input apparatus 506 including, for example, a touch screen, a touchpad, a keyboard, a mouse, a camera, a microphone, an accelerometer, a gyroscope, etc.; an output apparatus 507 including, for example, a liquid crystal display (LCD), a speaker, a vibrator, etc.; a storage apparatus 508 including, for example, a magnetic tape, a hard disk, etc.; and communication apparatus 509. The communication apparatus 509 may allow the electronic device 500 to communicate with other devices wirelessly or by wire to exchange data. Although FIG. 9 shows an electronic device 500 with various apparatuses, it should be understood that it is not required to implement or have all the devices shown. More or fewer devices may be implemented or have alternatively.

In particular, according to an embodiment of the present disclosure, the process described above with reference to the flowchart can be implemented as a computer software program. For example, an embodiment of the present disclosure includes a computer program product, which includes a computer program carried on a non-transitory computer-readable medium, and the computer program contains program code for executing the method shown in the flowchart. In such an embodiment, the computer program can be downloaded and installed from a network through a communication apparatus 509, or installed from a storage apparatus 508, or installed from a ROM 502. When the computer program is executed by the processing apparatus 501, the above-mentioned functions defined in the method of the embodiment of the present disclosure are executed.

The names of the messages or information exchanged between multiple apparatuses in the embodiments of the present disclosure are only used for illustrative purposes and are not used to limit the scope of these messages or information.

The electronic device provided by the embodiment of the present disclosure and the effect processing method provided by the above embodiment belong to the same disclosed concept. The technical details not fully described in this embodiment can be referred to the above embodiment, and this embodiment has the same beneficial effect as the above embodiment.

The embodiments of the present disclosure provide a computer storage medium on which a computer program is stored. When the program is executed by a processor, the effect processing method provided by the above embodiments is implemented.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM) , a read-only memory (ROM), an erasable programmable read-only memory (EPROM or flash memory), an optical fiber, a portable compact disk read-only memory (CD-ROM), an optical storage apparatus, a magnetic storage apparatus, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, which carries a computer-readable program code. This propagated data signal may take a variety of forms, including but not limited to electromagnetic signals, optical signals, or any suitable combination of the above. Computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

In some embodiments, the client and the server may communicate using any currently known or future developed network protocol such as HTTP (HyperText Transfer Protocol), and may be interconnected with any form or medium of digital data communication (e.g., a communication network). Examples of communication networks include a local area network (“LAN”), a wide area network (“WAN”), an internet (e.g., the Internet), and a peer-to-peer network (e.g., an ad hoc peer-to-peer network), as well as any currently known or future developed network.

The computer-readable medium may be included in the electronic device, or may exist independently without being installed in the electronic device.

The above-mentioned computer-readable medium carries one or more programs. When the above-mentioned one or more programs are executed by the electronic device, causing the electronic device to: obtain the augmented reality image captured by the shooting device, and generate a target effect image based on the augmented reality image; when the shooting device displays the first image area of the augmented reality image, the first effect area of the target effect image is displayed in the first image area; when it is detected that the shooting angle of the shooting device changes, the second image area of the augmented reality image is displayed, and the second effect area of the target effect image is displayed in the second image area.

The computer program code for performing the operation of the present disclosure may be written in one or more programming languages or a combination thereof, including, but not limited to, object-oriented programming languages, such as Java, Smalltalk, C++, and conventional procedural programming languages, such as “C” or similar programming languages. The program code may be executed entirely on the user's computer, partially on the user's computer, as a separate software package, partially on the user's computer and partially on a remote computer, or entirely on a remote computer or server. In cases involving a remote computer, the remote computer may be connected to the user's computer via any type of network, including a local area network (LAN) or a wide area network (WAN), or may be connected to an external computer (e.g., via the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a part of a code, and the module, the program segment or a part of the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The units involved in the embodiments described in the present disclosure may be implemented by software or hardware. The name of a unit does not limit the unit itself in some cases. For example, the first acquisition unit may also be described as a “unit for acquiring at least two Internet Protocol addresses”.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage apparatus, a magnetic storage apparatus, or any suitable combination of the foregoing.

According to one or more embodiments of the present disclosure, [Example 1] provides an effect processing method, including:
obtaining an augmented reality image captured by a shooting device, and generating a target effect image based on the augmented reality image;
when the shooting device displays the first image area of the augmented reality image, displaying the first effect area of the target effect image in the first image area;
when it is detected that the shooting angle of the shooting device changes, the second image area of the augmented reality image is displayed, and the second effect area of the target effect image is displayed in the second image area.

According to one or more embodiments of the present disclosure, [Example 2] provides the method of Example 1, further comprising:
generating an initial effect image based on the augmented reality image, and performing an optical processing on the initial effect image to obtain a target effect image, wherein the optical processing includes at least one of a scattering processing, a reflection processing, a refraction processing, a caustic processing and a highlight processing.

According to one or more embodiments of the present disclosure, [Example 3] provides the method of Example 2, further comprising:
performing the caustic processing on the initial effect image based on a preset caustic light map.

According to one or more embodiments of the present disclosure, [Example 4] provides the method of Example 3, further comprising:
determining a caustic sampling coordinate corresponding to an image pixel for each image pixel to be performed caustic processing in the initial effect image;
sampling a preset caustic light map based on the caustic sampling coordinate, and determining the caustic color value corresponding to the image pixel based on the sampling result;
performing a caustic processing on the image pixel based on the caustic color value corresponding to the image pixel.

According to one or more embodiments of the present disclosure, [Example 5] provides the method of Example 4, further comprising:
determining normal sampling coordinates corresponding to a preset normal texture map according to the world coordinate of the image pixel and illumination direction coordinate of a preset light source;
determining the caustic sampling coordinate corresponding to the image pixel according to the normal sampling coordinate.

According to one or more embodiments of the present disclosure, [Example 6] provides the method of Example 2, further comprising:
determining weight values of a preset first color value and a preset second color value respectively according to a component of a sight line vector corresponding to the augmented reality image in a preset direction;
determining a scattering value based on a preset first color value, a preset second color value, a weight value of the preset first color value, and a weight value of the preset second color value, and the scattering value is applied to the initial effect image.

According to one or more embodiments of the present disclosure, [Example 7] provides the method of Example 2, further comprising:
determining the direction of refracted light according to the preset incident light and the target effect image, and sampling the augmented reality image according to the direction of the refracted light to obtain a refracted color value;
determining the direction of reflected light according to the preset incident light and the target effect image, and sampling a preset environment map according to the direction of reflected light to obtain a reflected color value;
determining a reflectivity corresponding to the reflected color value and a refractive index corresponding to the refracted color value, and processing the initial effect image according to the refracted color value, the refractive index, the reflected color value and the reflectivity.

According to one or more embodiments of the present disclosure, [Example 8] provides the method of Example 1, further comprising:
rendering a preset effect object into the target effect image.

According to one or more embodiments of the present disclosure, [Example 9] provides the method of Example 8, further comprising:
determining target display information of a preset effect object in the target effect image, and rendering the effect object into the target effect image with the target display information, wherein the target display information includes at least one of display position, motion state, display color and display depth.

According to one or more embodiments of the present disclosure, [Example 10] provides an effect processing apparatus, including:
an effect generation module configured to obtain an augmented reality image captured by a shooting device, and generate a target effect image based on the augmented reality image;
an effect display module configured to display a first effect area of the target effect image in the first image area when the shooting device displays the first image area of the augmented reality image;
a display change module configured to display a second image area of the augmented reality image and display a second effect area of the target effect image in the second image area when it is detected that the shooting angle of the shooting device changes.

According to one or more embodiments of the present disclosure, [Example 11] provides an effect processing electronic device, including:
one or more processors;
a storage apparatus for storing one or more programs,

When the one or more programs are executed by the one or more processors, the one or more processors implement the effect processing method as described in any one of Examples 1 to 9.

According to one or more embodiments of the present disclosure, [Example 12] provides an effect processing storage medium, including:
when the computer executable instructions are executed by a computer processor, they are configured to perform the effect processing method described in any one of Examples 1 to 9.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) to form a technical solution.

In addition, although each operation is described in a specific order, this should not be understood as requiring these operations to be performed in the specific order shown or in a sequential order. Under certain circumstances, multitasking and parallel processing may be advantageous. Similarly, although some specific implementation details are included in the above discussion, these should not be interpreted as limiting the scope of the present disclosure. Some features described in the context of a separate embodiment can also be implemented in a single embodiment in combination. On the contrary, the various features described in the context of a single embodiment can also be implemented in multiple embodiments individually or in any suitable sub-combination mode.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

1. An effect processing method, comprising:
obtaining an augmented reality image captured by a shooting device, and generating a target effect image based on the augmented reality image;
displaying a first effect area of the target effect image in a first image area of the augmented reality image in response to the shooting device displaying the first image area; and
displaying a second image area of the augmented reality image and displaying a second effect area of the target effect image in the second image area in response to detecting that a shooting angle of the shooting device changes.

2. The effect processing method according to claim 1, wherein generating a target effect image based on the augmented reality image comprises:
generating an initial effect image based on the augmented reality image, and performing an optical processing on the initial effect image to obtain the target effect image, wherein the optical processing includes at least one of a scattering processing, a reflection processing, a refraction processing, a caustic processing and a highlight processing.

3. The effect processing method according to claim 2, wherein performing a caustic processing on the initial effect image comprises:
performing the caustic processing on the initial effect image based on a preset caustic light map.

4. The effect processing method according to claim 3, wherein performing the caustic processing on the initial effect image based on a preset caustic light map comprises:
determining a caustic sampling coordinate corresponding to an image pixel for each image pixel to be performed a caustic processing in the initial effect image;
sampling a preset caustic light map based on the caustic sampling coordinate, and determining a caustic color value corresponding to the image pixel based on a sampling result; and
performing the caustic processing on the image pixel based on the caustic color value corresponding to the image pixel.

5. The effect processing method according to claim 4, wherein determining a caustic sampling coordinate corresponding to an image pixel comprises:
determining a normal sampling coordinate corresponding to a preset normal texture map according to a world coordinate of the image pixel and an illumination direction coordinate of a preset light source;
determining the caustic sampling coordinate corresponding to the image pixel according to the normal sampling coordinate.

6. The effect processing method according to claim 2, wherein performing a scattering processing on the initial effect image comprises:
determining weight values of a preset first color value and a preset second color value respectively according to a component of a sight line vector corresponding to the augmented reality image in a preset direction; and
determining a scattering value based on the preset first color value, the preset second color value, a weight value of the preset first color value, and a weight value of the preset second color value, and the scattering value being applied to the initial effect image.

7. The effect processing method according to claim 2, wherein the optical processing includes a reflection processing and a refraction processing, and performing the optical processing on the initial effect image includes:
determining a direction of refracted light according to preset incident light and the target effect image, and sampling the augmented reality image according to the direction of the refracted light to obtain a refracted color value;
determining a direction of reflected light according to preset incident light and the target effect image, and sampling a preset environment map according to the direction of reflected light to obtain a reflected color value;
determining a reflectivity corresponding to the reflected color value and a refractive index corresponding to the refracted color value, and processing the initial effect image according to the refracted color value, the refractive index, the reflected color value and the reflectivity.

8. The effect processing method according to claim 1, further comprising:
rendering a preset effect object into the target effect image.

9. The effect processing method according to claim 8, wherein rendering a preset effect object into the target effect image comprises:
determining target display information of a preset effect object in the target effect image, and rendering the effect object into the target effect image with the target display information, wherein the target display information includes at least one of display position, motion state, display color and display depth.

10. (canceled)

11. An electronic device, wherein the electronic device comprises:
one or more processors;
a storage apparatus for storing one or more programs,
when the one or more programs are executed by the one or more processors, the one or more processors are caused to execute:
obtaining an augmented reality image captured by a shooting device, and generating a target effect image based on the augmented reality image;
displaying a first effect area of the target effect image in a first image area of the augmented reality image in response to the shooting device displaying the first image area; and
displaying a second image area of the augmented reality image and a second effect area of the target effect image being displayed in the second image area in response to detecting that a shooting angle of the shooting device changes.

12. The electronic device according to claim 11, wherein the one or more programs causing the one or more processors to generate a target effect image based on the augmented reality image comprise instructions to:
generate an initial effect image based on the augmented reality image, and perform an optical processing on the initial effect image to obtain the target effect image, wherein the optical processing includes at least one of a scattering processing, a reflection processing, a refraction processing, a caustic processing and a highlight processing.

13. The electronic device according to claim 12, wherein the one or more programs causing the one or more processors to perform a caustic processing on the initial effect image comprise instructions to:
perform the caustic processing on the initial effect image based on a preset caustic light map.

14. The electronic device according to claim 13, wherein the one or more programs causing the one or more processors to perform the caustic processing on the initial effect image based on the preset caustic light map comprise instructions to:
determine a caustic sampling coordinate corresponding to an image pixel for each image pixel to be performed a caustic processing in the initial effect image;
sample a preset caustic light map based on the caustic sampling coordinate, and determining a caustic color value corresponding to the image pixel based on the sampling result; and
perform the caustic processing on the image pixel based on the caustic color value corresponding to the image pixel.

15. The electronic device according to claim 14, wherein the one or more programs causing the one or more processors to determine a caustic sampling coordinate corresponding to an image pixel comprise instructions to:
determine a caustic sampling coordinate corresponding to an image pixel for each image pixel to be performed a caustic processing in the initial effect image;
sample a preset caustic light map based on the caustic sampling coordinate, and determining a caustic color value corresponding to the image pixel based on the sampling result; and
perform the caustic processing on the image pixel based on the caustic color value corresponding to the image pixel.

16. The electronic device according to claim 12, wherein the one or more programs causing the one or more processors to perform a scattering processing on the initial effect image comprise instructions to:
determine weight values of a preset first color value and a preset second color value respectively according to a component of a sight line vector corresponding to the augmented reality image in a preset direction; and
determine a scattering value based on the preset first color value, the preset second color value, a weight value of the preset first color value, and a weight value of the preset second color value, and the scattering value being applied to the initial effect image.

17. The electronic device according to claim 12, wherein the optical processing comprises a reflection processing and a refraction processing; and the one or more programs causing the one or more processors to perform an optical processing on the initial effect image comprise instructions to:
determine a direction of refracted light according to preset incident light and the target effect image, and sampling the augmented reality image according to the direction of refracted light to obtain a refracted color value;
determine the direction of reflected light according to preset incident light and the target effect image, and sampling a preset environment map according to the direction of reflected light to obtain a reflected color value;
determine a reflectivity corresponding to the reflected color value and a refractive index corresponding to the refracted color value, and processing the initial effect image according to the refracted color value, the refractive index, the reflected color value and the reflectivity.

18. The electronic device according to claim 11, wherein when the one or more programs are executed by the one or more processors, the one or more processors are also caused to:
render a preset effect object into the target effect image.

19. The electronic device according to claim 18, wherein the one or more programs causing the one or more processors to render a preset effect object into the target effect image comprise instructions to:
determine target display information of a preset effect object in the target effect image, and rendering the effect object into the target effect image with the target display information, wherein the target display information includes at least one of display position, motion state, display color and display depth.

20. A non-transitory storage medium comprising computer executable instructions, wherein the computer executable instructions when executed by a computer processor, are configured to:
obtain an augmented reality image captured by a shooting device, and generating a target effect image based on the augmented reality image;
display a first effect area of the target effect image in a first image area of the augmented reality image in response to the shooting device displaying the first image area; and
display a second image area of the augmented reality image and displaying a second effect area of the target effect image in the second image area in response to detecting that a shooting angle of the shooting device changes.

21. The non-transitory storage medium of claim 20, wherein the computer executable instructions to generate a target effect image based on the augmented reality image comprise instructions to:
generate an initial effect image based on the augmented reality image, and performing an optical processing on the initial effect image to obtain the target effect image, wherein the optical processing includes at least one of a scattering processing, a reflection processing, a refraction processing, a caustic processing and a highlight processing.
